(19) United States
(12) Patent Application Publication
(10) Pub. No.: US 2012/0293549 A1
(43) Pub. Date: Nov. 22, 2012

(54) COMPUTER-READABLE STORAGE MEDIUM HAVING INFORMATION PROCESSING PROGRAM STORED THEREIN, INFORMATION PROCESSING APPARATUS, INFORMATION PROCESSING SYSTEM, AND INFORMATION PROCESSING METHOD

(75) Inventor: Satoru OSAKO, Kyoto (JP)

(73) Assignee: NINTENDO CO., LTD., Kyoto (JP)

(21) Appl. No.: 13/191,869

(22) Filed: Jul. 27, 2011

(30) Foreign Application Priority Data
May 20, 2011 (JP) 2011-113860

(51) Int. Cl. G09G 5/377; G06T 3/60

(52) U.S. Cl. 345/633; 345/649

(57) ABSTRACT

In a game apparatus, a plurality of images of a real object are taken from a plurality of directions, and the plurality of images are previously stored in a storage device so as to be associated with imaging directions. The game apparatus causes an outer imaging section to take an image including a marker positioned in a real space, and detects the marker included in the taken image. The game apparatus calculates, based on the detected marker, a position of the outer imaging section in a marker coordinate system based on the marker. The game apparatus calculates a vector indicating a direction from the position of the outer imaging section toward the marker, selects, based on the vector, an image from among the plurality of images stored in the storage device, and displays the selected image on the upper LCD.

### CROSS REFERENCE TO RELATED APPLICATION

The disclosure of Japanese Patent Application No. 2011-113860, filed on May 20, 2011, is incorporated herein by reference.

### BACKGROUND OF THE INVENTION

1. Field of the Invention

The present invention relates to a computer-readable storage medium having stored therein an information processing program, an information processing apparatus, an information processing system, and an information processing method for causing a display device to display an image.

2. Description of the Background Art

A device for taking an image of a card placed in a real space by means of a camera, and displaying a virtual object at a position at which the card is displayed has been known to date. For example, according to Japanese Laid-Open Patent Publication No. 2006-72667 (Patent Document 1), an image of a card placed in a real space is taken by a camera connected to a device, and an orientation and a direction of the card in the real space, and a distance between the camera and the card in the real, space are calculated based on the taken image. A virtual object to be displayed by a display device is varied according to the orientation, the direction, and the distance having been calculated.

As described in Patent Document 1, in conventional arts, a virtual object is positioned in a virtual space, and an image of the virtual space including the virtual object is taken by a virtual camera, thereby displaying an image of the virtual object by a display device.

### SUMMARY OF THE INVENTION

Therefore, an object of the present invention is to make available information processing technology capable of displaying various images by a display device in a novel manner.

In order to attain the above-described object, the present invention has the following features.

One aspect of the present invention is directed to a computer-readable storage medium having stored therein an information processing program which causes a computer of an information processing apparatus to function as: image obtaining means; specific object detection means; calculation means; image selection means; and display control means. The image obtaining means obtains an image taken by imaging means. The specific object detection means detects a specific object in the image obtained by the image obtaining means. The calculation means calculates an orientation of one of the specific object and the imaging means relative to the other thereof. The image selection means selects at least one image from among a plurality of images which are previously stored in storage means, based on the orientation calculated by the calculation means. The display control means causes a display device to display the at least one image selected by the image selection means.

In the features described above, a relative orientation between the imaging means and the specific object included in an image taken by the imaging means is calculated, and at least one image can be selected, based on the orientation, from among a plurality of images (for example, photographs of a real object or CG images of a virtual object) which are previously stored in the storage means, and the selected image can be displayed.

Further, according to another aspect of the present invention, the plurality of images stored in the storage means may be a plurality of images representing a predetermined object viewed from a plurality of directions. The image selection means selects the at least one image based on the orientation, from among the plurality of images.

In the features described above, images (including, for example, photographed images and handdrawn images) of a specific object (a real object or a virtual object) viewed from a plurality of directions, are previously stored in the storage means, and an image can be selected from among the plurality of images based on the orientation, and the selected image can be displayed.

Further, according to another aspect of the present invention, the calculation means may calculate a position of one of the specific object and the imaging means relative to the other thereof. The image selection means selects an image from among the plurality of images, based on a direction from the position calculated by the calculation means toward a predetermined position satisfying a predetermined positional relationship with the specific object, or based on a direction from the predetermined position toward the position calculated by the calculation means.

In the features described above, for example, a position of the imaging means is calculated relative to the specific object, and an image can be selected from among the plurality of images stored in the storage means, based on a direction from the position of the imaging means toward a predetermined position (for example, the center of the specific object). Thus, an image can be selected according to a direction in which the specific object is taken by the imaging means, and the selected image can be displayed by the display device.

Further, according to another aspect of the present invention, the display control means may include virtual camera setting means, positioning means, and image generation means. The virtual camera setting means sets a virtual camera in a virtual space, based on the position calculated by the calculation means. The positioning means positions, in the virtual space, an image object representing the selected image such that the image object is oriented toward the virtual camera. The image generation means generates an image by taking an image of the virtual space with the virtual camera. The display control means causes the display device to display the image generated by the image generation means.

In the features described above, the selected image can be positioned in the virtual space, and an image of the virtual space can be taken by the virtual camera. Thus, an image including the selected image can be generated, and the generated image can be displayed by the display device.

Further, according to another aspect of the present invention, the image object may be a plate-shaped object on which the selected image is mapped as a texture.

In the features described above, the image object having the selected image mapped thereon is positioned in the virtual space, and an image of the virtual space is taken by the virtual camera, thereby enabling generation of an image including the selected image.

Further, according to another aspect of the present invention, a predetermined virtual object may be positioned in the virtual space. The image generation means generates an image by taking, with the virtual camera, an image of the virtual space including the predetermined virtual object and the selected image.

In the features described above, an image including a virtual object and the selected image can be generated, and the generated image can be displayed by the display device.

Further, according to another aspect of the present invention, the positioning means may position the selected image in the virtual space so as to prevent the selected image from contacting with the predetermined virtual object.

Further, according to another aspect of the present invention, the calculation means may calculate a position of one of the specific object and the imaging means relative to the other thereof The display control means causes the display device to display the at least one image having been selected so as to vary, when the at least one image having been selected is displayed by the display device, the size of the at least one image having been selected, according to the position calculated by the calculation means.

In the features described above, the size of the selected image which is displayed can be varied according to the position calculated by the calculation means. For example, when the specific object and the imaging means are distant from each other, the selected image can be reduced in size, and the selected image reduced in size can be displayed by the display device.

In the features described above, in a case where the virtual object is positioned in the virtual space, when the virtual object and the selected image are displayed by the display device, an image can be displayed so as to prevent the image from looking strange.

Further, according to another aspect of the present invention, the display control means may cause the display device to display a superimposed image obtained by superimposing the at least one image having been selected, on one of the image taken by the imaging means, and a real space which is viewed through a screen of the display device.

In the features described above, for example, the selected image can be superimposed on the image taken by the imaging means, and the superimposed image can be displayed by the display device. Further, for example, the selected image is superimposed at a screen through which light in the real space can be transmitted, so that the selected image can be superimposed on the real space, and the superimposed image can be displayed.

Further, according to another aspect of the present invention, the imaging means may include a first imaging section and a second imaging section. The calculation means calculates a first orientation representing an orientation of one of the specific object and the first imaging section relative to the other thereof, and a second orientation representing an orientation of one of the specific object and the second imaging section relative to the other thereof. The image selection means selects a first image from among the plurality of images, based on the first orientation calculated by the calculation means, and selects a second image from among the plurality of images, based on the second orientation calculated by the calculation means. The display control means causes a display device capable of stereoscopically viewable display to display a stereoscopically viewable image by displaying, on the display device, the first image and the second image which are selected by the image selection means.

In the features described above, the first image and the second image are selected based on the first orientation of the first imaging section and the second orientation of the second imaging section, respectively, and can be displayed by the display device capable of stereoscopically viewable display. Thus, a stereoscopically viewable image can be displayed by the display device.

Further, according to another aspect of the present invention, the plurality of images may be images obtained by taking, with a real camera, images of a real object positioned in a real space.

In the features described above, images of a real object are previously stored in the storage means, and can be displayed by the display device.

Further, according to another aspect of the present invention, the plurality of images may be images obtained by taking, with a monocular real camera, images of a real object positioned in a real space. The image selection means selects the first image from among the plurality of images taken by the monocular real camera, based on the first orientation, and selects the second image from among the plurality of images taken by the monocular real camera, based on the second orientation.

In the features described above, a plurality of images taken by the monocular real camera are previously stored, and two images are selected from among the plurality of images, thereby causing the display device to display a stereoscopically viewable image.

Further, according to another aspect of the present invention, the plurality of images may be images obtained by taking, with a virtual camera, images of a virtual object positioned in a virtual space.

In the features described above, images of a virtual object are previously stored in the storage means, and can be displayed by the display device.

Further, the present invention may be implemented as an information processing apparatus in which each means described above is realized. Furthermore, the present invention may be implemented as one information processing system in which a plurality of components for realizing the means described above cooperate with each other. The information processing system may be configured as one device, or configured so as to include a plurality of devices. Moreover, the present invention may be implemented as an information processing method including process steps executed by the means described above.

Further, still another aspect of the present invention may be directed to an information processing system including an information processing apparatus and a marker. The information processing apparatus includes: image obtaining means; specific object detection means; calculation means; image selection means; and display control means. The image obtaining means obtains an image taken by imaging means. The specific object detection means detects a specific object in the image obtained by the image obtaining means. The calculation means calculates an orientation of one of the specific object and the imaging means relative to the other thereof. The image selection means selects at least one image from among a plurality of images which are previously stored in storage means, based on the orientation calculated by the calculation means. The display control means causes a display device to display the at least one image selected by the image selection means.

According to the present invention, various images can be displayed by a display device in a novel manner.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of an outer appearance of a game apparatus 10 in opened state;

FIG. 2A is a left side view of the game apparatus 10 in closed state;

FIG. 2B is a front view of the game apparatus 10 in the closed state;

FIG. 2C is a right side view of the game apparatus 10 in the closed state;

FIG. 2D is a rear view of the game apparatus 10 in the closed state;

FIG. 3 is a block diagram illustrating an internal configuration of the game apparatus 10;

FIG. 4 is a diagram illustrating an exemplary predetermined real object 50;

FIG. 5 is a diagram illustrating a position of a real camera which is set so as to take images of the real object 50 by the real camera from a plurality of directions;

FIG. 6A is a diagram illustrating an exemplary actual image 501 obtained when an image of the real object 50 is taken at a position P1;

FIG. 6B is a diagram illustrating an exemplary actual image 502 obtained when an image of the real object 50 is taken at a position P2;

FIG. 6C is a diagram illustrating an exemplary actual image 50i obtained when an image of the real object 50 is taken at a position Pi;

FIG. 7 is a diagram illustrating an actual image table 60 containing data of a plurality of actual images which are previously stored in the game apparatus 10;

FIG. 8 is a diagram illustrating an image displayed on an upper LCD 22 in a case where an image of a marker positioned in the real space is taken by an outer imaging section 23 of the game apparatus 10;

FIG. 9 is a diagram illustrating an image displayed on the upper LCD 22 in a case where an image of a marker 52 positioned in the real space is taken by the outer imaging section 23 of the game apparatus 10 from a direction different from a direction shown in FIG. 8;

FIG. 10 is a diagram illustrating a memory map of a RAM (a main memory 32 and the like) of the game apparatus 10;

FIG. 11 is a main flow chart showing in detail a display process according to a present embodiment;

FIG. 12 is a flow chart showing in detail a left virtual camera image generation process (step S102);

FIG. 13 is a diagram illustrating a positional relationship between a marker coordinate system defined on the marker 52, and a left virtual camera 63a set in a virtual space;

FIG. 14 illustrates a left virtual camera direction vector calculated in step S203;

FIG. 15 is a diagram illustrating a state in which an image 61 selected in step S204 is positioned in the virtual space; and

FIG. 16 is a diagram illustrating an outline of a display process according to another embodiment.

### DESCRIPTION OF THE PREFERRED EMBODIMENTS

(Configuration of Game Apparatus)

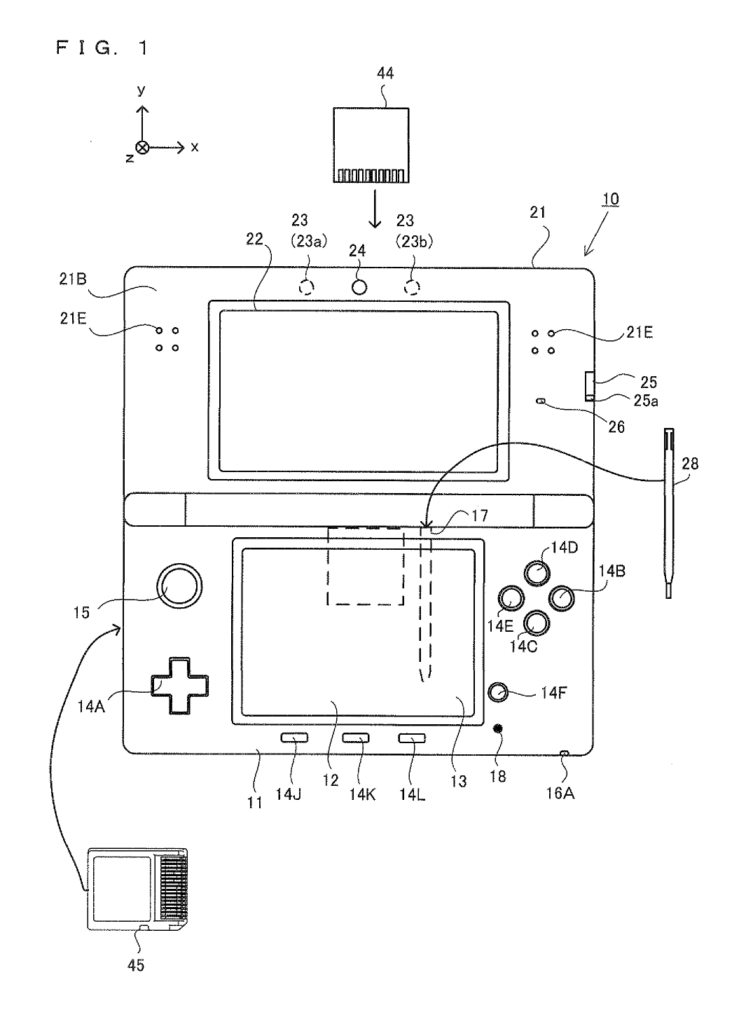

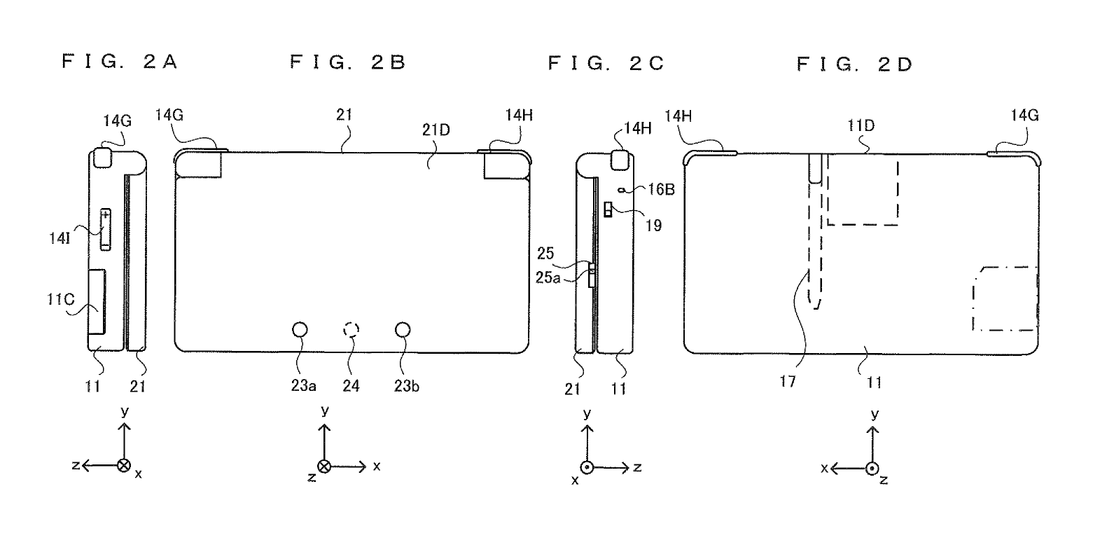

Hereinafter, a game apparatus according to an embodiment of the present invention will be described. FIG. 1 is a front view of an outer appearance of a game apparatus 10 in opened state. FIG. 2A is a left side view of the game apparatus 10 in closed state. FIG. 2B is a front view of the game apparatus 10 in the closed state. FIG. 2C is a right side view of the game apparatus 10 in the closed state. FIG. 2D is a rear view of the game apparatus 10 in the closed state. The game apparatus 10 is a hand-held game apparatus, and is configured to be foldable as shown in FIG. 1 and FIGS. 2A to 2D. FIG. 1 shows the game apparatus 10 in the opened state, and FIGS. 2A to 2D show the game apparatus 10 in the closed state. The game apparatus 10 is able to take an image by means of an imaging section, display the taken image on a screen, and store data of the taken image. Further, the game apparatus 10 can execute a game program which is stored in an exchangeable memory card or a game program which is received from a server or another game apparatus, and can display, on the screen, an image generated by computer graphics processing, such as an image taken by a virtual camera set in a virtual space, for example.

Firstly, an external structure of the game apparatus 10 will be described with reference to FIG. 1, and FIGS. 2A to 2D. The game apparatus 10 includes a lower housing 11 and an upper housing 21 as shown in FIG. 1, and FIGS. 2A to 2D. The lower housing 11 and the upper housing 21 are connected to each other so as to be openable and closable (foldable). In the present embodiment, the lower housing 11 and the upper housing 21 are each formed in a horizontally long plate-like rectangular shape, and are connected to each other at long side portions thereof so as to be pivotable with respect to each other.

(Description of Lower Housing)

Firstly, a structure of the lower housing 11 will be described. As shown in FIG. 1, and FIGS. 2A to 2D, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The number of pixels of the lower LCD 12 may be, for example, 320 dots×240 dots (the horizontal line×the vertical line). The lower LCD 12 is a display device for displaying an image in a planar manner (not in a stereoscopically viewable manner), which is different from an upper LCD 22 as described below. Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12. In the present embodiment, the touch panel 13 may be, but is not limited to, a resistive film type touch panel. A touch panel of any type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIG. 1 and FIG. 2D) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a finger of a user may be used for making an input on the touch panel 13, in addition to the touch pen 28.

The operation buttons 14A to 14L are each an input device for making a predetermined input. As shown in FIG. 1, among the operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The buttons 14A to 14E, the selection button 14J, the HOME button 14K, and the start button 14L are assigned functions, respectively, in accordance with a program executed by the game apparatus 10, as necessary. For example, the cross button 14A is used for selection operation and the like, and the operation buttons 14B to 14E are used for, for example, determination operation and cancellation operation. The power button 14F is used for powering the game apparatus 10 on/off.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 10. For example, when a game in which a predetermined object emerges in a three-dimensional virtual space is executed by the game apparatus 10, the analog stick 15 acts as an input device for moving the predetermined object in the three-dimensional virtual space. In this case, the predetermined object is moved in a direction in which the top corresponding to the key of the analog stick 15 slides. As the analog stick 15, a component which enables an analog input by being tilted by a predetermined amount, in any direction, such as the upward, the downward, the rightward, the leftward, or the diagonal direction, may be used.

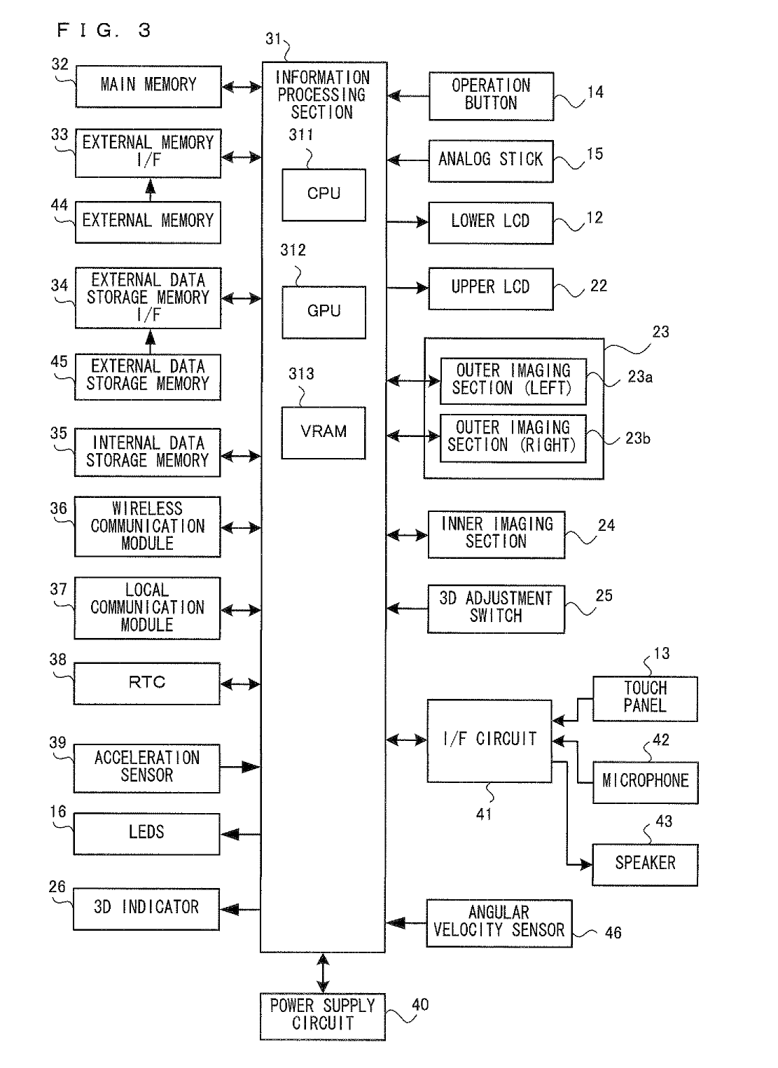

Further, the microphone hole 18 is provided on the inner side surface of the lower housing 11. Under the microphone hole 18, a microphone 42 (see FIG. 3) is provided as a sound input device described below, and the microphone 42 detects for a sound from the outside of the game apparatus 10.

As shown in FIG. 2B and FIG. 2D, an L button 14G and an R button 14H are provided on the upper side surface of the lower housing 11. The L button 14G and the R button 14H act as shutter buttons (imaging instruction buttons) of the imaging section. Further, as shown in FIG. 2A, a sound volume button 14I is provided on the left side surface of the lower housing 11. The sound volume button 14I is used for adjusting a sound volume of a speaker of the game apparatus 10.

As shown in FIG. 2A, a cover section 11C is provided on the left side surface of the lower housing 11 so as to be operable and closable. Inside the cover section 11C, a connector (not shown) is provided for electrically connecting between the game apparatus 10 and an external data storage memory 45. The external data storage memory 45 is detachably mounted to the connector. The external data storage memory 45 is used for, for example, recording (storing) data of an image taken by the game apparatus 10.

Further, as shown in FIG. 2D, an insertion opening 11D through which an external memory 44 having a game program stored therein is inserted is provided on the upper side surface of the lower housing 11. A connector (not shown) for electrically connecting between the game apparatus 10 and the external memory 44 in a detachable manner is provided inside the insertion opening 11D. A predetermined game program is executed by connecting the external memory 44 to the game apparatus 10.

Further, as shown in FIG. 1 and FIG. 2C, the first LED 16A for notifying a user of an ON/OFF state of a power supply of the game apparatus 10 is provided on the lower side surface of the lower housing 11, and the second LED 16B for notifying a user of an establishment state of a wireless communication of the game apparatus 10 is provided on the right side surface of the lower housing 11. The game apparatus 10 can make wireless communication with other devices, and the second LED 16B is lit up when the wireless communication is established. The game apparatus 10 has a function of connecting to a wireless LAN in a method compliant with, for example, IEEE 802.11 b/g standard. A wireless switch 19 for enabling/disabling the function of the wireless communication is provided on the right side surface of the lower housing 11 (see FIG. 2C).

A rechargeable battery acting as a power supply for the game apparatus 10 is accommodated in the lower housing 11, and the battery can be charged through a terminal provided on a side surface (for example, the upper side surface) of the lower housing 11, which is not shown.

(Description of Upper Housing)

Next, a structure of the upper housing 21 will be described. As shown in FIG. 1, and FIGS. 2A to 2D, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided. Hereinafter, theses components will be described in detail.

As shown in FIG. 1, the upper LCD 22 is accommodated in the upper housing 21. The number of pixels of the upper LCD 22 may be, for example, 800 dots×240 dots (the horizontal line x the vertical line). Although, in the present embodiment, the upper LCD 22 is an LCD, a display device using an EL (Electro Luminescence), or the like may be used, for example. In addition, a display device having any resolution may be used as the upper LCD 22.

The upper LCD 22 is a display device capable of displaying a stereoscopically viewable image. Further, in the present embodiment, an image for a left eye and an image for a right eye are displayed by using substantially the same display area. Specifically, the upper LCD 22 is a display device using a method in which the image for a left eye and the image for a right eye are alternately displayed in the horizontal direction in predetermined units (for example, every other line). Alternatively, the upper LCD 22 may be a display device using a display method in which the image for a left eye and the image for a right eye alternate every predetermined time period, and a user can view the image for the left eye with his/her left eye, and the image for the right eye with his/her right eye by using glasses. In the present embodiment, the upper LCD 22 is a display device capable of displaying an image which is stereoscopically viewable with naked eyes. A lenticular lens type display device or a parallax barrier type display device is used which enables the image for a left eye and the image for a right eye, which are alternately displayed in the horizontal direction, to be separately viewed by the left eye and the right eye, respectively. In the present embodiment, the upper LCD 22 of a parallax barrier type is used. The upper LCD 22 displays, by using the image for a right eye and the image for a left eye, an image (a stereoscopic image) which is stereoscopically viewable with naked eyes. That is, the upper LCD 22 allows a user to view the image for a left eye with her/his left eye, and the image for a right eye with her/his right eye by utilizing a parallax barrier, so that a stereoscopic image (a stereoscopically viewable image) exerting a stereoscopic effect for a user can be displayed. Further, the upper LCD 22 may disable the parallax barrier. When the parallax barrier is disabled, an image can be displayed in a planar manner (it is possible to display a planar viewable image which is different from a stereoscopically viewable image as described above. Specifically, a display mode is used in which the same displayed image is viewed with a left eye and a right eye.). Thus, the upper LCD 22 is a display device capable of switching between a stereoscopic display mode for displaying a stereoscopically viewable image and a planar display mode for displaying an image in a planar manner (for displaying a planar viewable image). The switching of the display mode is performed by the 3D adjustment switch 25 described below.

Two imaging sections (23a and 23b) provided on the outer side surface (the back surface reverse of the main surface on which the upper LCD 22 is provided) 21D of the upper housing 21 are generically referred to as the outer imaging section 23. The imaging directions of the outer imaging section (left) 23a and the outer imaging section (right) 23b are each the same as the outward normal direction of the outer side surface 21D. The outer imaging section (left) 23a and the outer imaging section (right) 23b can be used as a stereo camera depending on a program executed by the game apparatus 10. Each of the outer imaging section (left) 23a and the outer imaging section (right) 23b includes an imaging device, such as a CCD image sensor or a CMOS image sensor, having the same predetermined resolution, and a lens. The lens may have a zooming mechanism.

The inner imaging section 24 is positioned on the inner side surface (main surface) 21B of the upper housing 21, and acts as an imaging section which has an imaging direction which is the same as the inward normal direction of the inner side surface. The inner imaging section 24 includes an imaging device, such as a CCD image sensor or a CMOS image sensor, having a predetermined resolution, and a lens. The lens may have a zooming mechanism.

The 3D adjustment switch 25 is a slide switch, and is used for switching a display mode of the upper LCD 22 as described above. Further, the 3D adjustment switch 25 is used for adjusting the stereoscopic effect of a stereoscopically viewable image (stereoscopic image) which is displayed on the upper LCD 22. A slider 25a of the 3D adjustment switch 25 is slidable to any position in a predetermined direction (along the longitudinal direction of the right side surface), and a display mode of the upper LCD 22 is determined in accordance with the position of the slider 25a. A manner in which the stereoscopic image is viewable is adjusted in accordance with the position of the slider 25a. Specifically, an amount of deviation in the horizontal direction between a position of an image for a right eye and a position of an image for a left eye is adjusted in accordance with the position of the slider 25a.

The 3D indicator 26 indicates whether or not a stereoscopically viewable image can be displayed on the upper LCD 22. The 3D indicator 26 is implemented as a LED, and is lit up when the stereoscopically viewable image can be displayed on the upper LCD 22. The 3D indicator 26 may be lit up only when the program processing for displaying a stereoscopically viewable image is executed.

Further, a speaker hole 21E is provided on the inner side surface of the upper housing 21. A sound is outputted through the speaker hole 21E from a speaker 43 described below.

(Internal Configuration of Game Apparatus 10)

Next, an internal electrical configuration of the game apparatus 10 will be described with reference to FIG. 3. FIG. 3 is a block diagram illustrating an internal configuration of the game apparatus 10. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. The CPU 311 of the information processing section 31 executes a program stored in a memory (such as, for example, the external memory 44 connected to the external memory I/F 33, or the internal data storage memory 35) of the game apparatus 10, to execute a process according to the program. The program executed by the CPU 311 of the information processing section 31 may be acquired from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 44. The external data storage memory I/F 34 is an interface for detachably connecting to the external data storage memory 45.

The main memory 32 is volatile storage means used as a work area and a buffer area for (the CPU 311 of) the information processing section 31. That is, the main memory 32 temporarily stores various types of data used for the process based on the program, and temporarily stores a program acquired from the outside (the external memory 44, another device, or the like), for example. In the present embodiment, for example, a PSRAM (Pseudo-SRAM) is used as the main memory 32.

The external memory 44 is nonvolatile storage means for storing a program executed by the information processing section 31. The external memory 44 is implemented as, for example, a read-only semiconductor memory. When the external memory 44 is connected to the external memory I/F 33, the information processing section 31 can load a program stored in the external memory 44. A predetermined process is performed by the program loaded by the information processing section 31 being executed. The external data storage memory 45 is implemented as a nonvolatile readable and writable memory (for example, a NAND flash memory), and is used for storing predetermined data. For example, images taken by the outer imaging section 23 and/or images taken by another device are stored in the external data storage memory 45. When the external data storage memory 45 is connected to the external data storage memory I/F 34, the information processing section 31 loads an image stored in the external data storage memory 45, and the image can be displayed on the upper LCD 22 and/or the lower LCD 12.

The internal data storage memory 35 is implemented as a nonvolatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method compliant with, for example, IEEE 802.11 b/g standard. The local communication module 37 has a function of performing wireless communication with the same type of game apparatus in a predetermined communication mode (for example, communication based on unique protocol, or infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial (xyz-axial) directions, respectively. The acceleration sensor 39 is provided inside the lower housing 11. In the acceleration sensor 39, as shown in FIG. 1, the long side direction of the lower housing 11 is defined as x axial direction, the short side direction of the lower housing 11 is defined as y axial direction, and the direction orthogonal to the inner side surface (main surface) of the lower housing 11 is defined as z axial direction, thereby detecting magnitudes of the linear accelerations for the respective axes. The acceleration sensor 39 is, for example, an electrostatic capacitance type acceleration sensor. However, another type of acceleration sensor may be used. The acceleration sensor 39 may be an acceleration sensor for detecting magnitude of acceleration for one axial direction or two-axial directions. The information processing section 31 can receive data (acceleration data) representing accelerations detected by the acceleration sensor 39, and detect an orientation and a motion of the game apparatus 10.

The RTC 38 and the power supply circuit 40 are connected to the information processing section 31. The RTC 38 counts time, and outputs the time to the information processing section 31. The information processing section 31 calculates a current time (date) based on the time counted by the RTC 38. The power supply circuit 40 controls power from the power supply (the rechargeable battery accommodated in the lower housing 11 as described above) of the game apparatus 10, and supplies power to each component of the game apparatus 10.

The I/F circuit 41 is connected to the information processing section 31. The microphone 42 and the speaker 43 are connected to the I/F circuit 41. Specifically, the speaker 43 is connected to the I/F circuit 41 through an amplifier which is not shown. The microphone 42 detects a voice from a user, and outputs a sound signal to the I/F circuit 41. The amplifier amplifies a sound signal outputted from the I/F circuit 41, and a sound is outputted from the speaker 43. The touch panel 13 is connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents a coordinate of a position, on an input surface of the touch panel 13, on which an input is made. The touch panel control circuit reads a signal outputted from the touch panel 13, and generates the touch position data every predetermined time. The information processing section 31 acquires the touch position data, to recognize a position on which an input is made on the touch panel 13.

The operation button 14 includes the operation buttons 14A to 14L described above, and is connected to the information processing section 31. Operation data representing an input state of each of the operation buttons 14A to 14I is outputted from the operation button 14 to the information processing section 31, and the input state indicates whether or not each of the operation buttons 14A to 14I has been pressed. The information processing section 31 acquires the operation data from the operation button 14 to perform a process in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 causes the upper LCD 22 to display a stereoscopic image (stereoscopically viewable image).

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye, which are stored in the VRAM 313 of the information processing section 31, are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically viewable image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31, and output data of the taken image to the information processing section 31.

The 3D adjustment switch 25 is connected to the information processing section 31. The 3D adjustment switch 25 transmits, to the information processing section 31, an electrical signal in accordance with the position of the slider 25a.

The 3D indicator 26 is connected to the information processing section 31. The information processing section 31 controls whether or not the 3D indicator 26 is to be lit up. For example, the information processing section 31 lights up the 3D indicator 26 when the stereoscopically viewable image can be displayed on the upper LCD 22.

An angular velocity sensor 46 is connected to the information processing section 31. The angular velocity sensor 46 detects angular velocities around axes (x-axis, y-axis, and z-axis), respectively. The game apparatus 10 is able to calculate an orientation of the game apparatus 10 in a real space, based on the angular velocity which is sequentially detected by the angular velocity sensor 46. Specifically, the game apparatus 10 integrates the angular velocity around each axis which is detected by the angular velocity sensor 46, with respect to time, to enable calculation of a rotation angle of the game apparatus 10 around each axis. This is the end of description of the internal configuration of the game apparatus 10.

(Outline of Display Process According to the Present Embodiment)

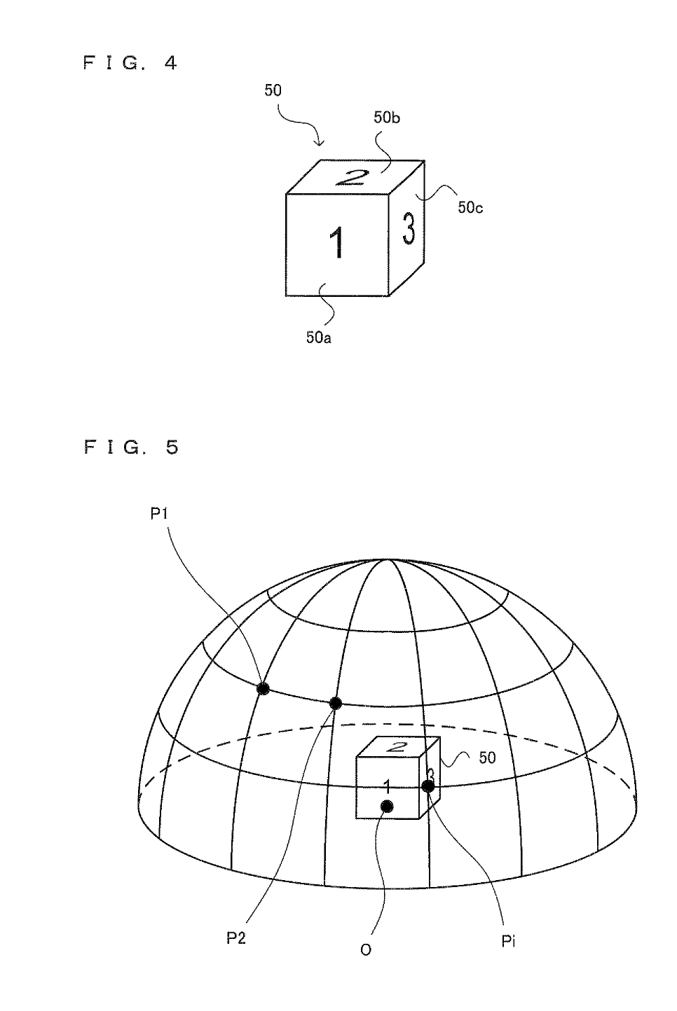

Next, an outline of a display process performed by the game apparatus 10 according to the present embodiment will be described with reference to FIG. 4 to FIG. 9. In the present embodiment, images of a predetermined real object positioned in a real space are previously taken from a plurality of directions, and stored. Two images are selected from among the plurality of images, and the selected two images are displayed on the upper LCD 22. Specifically, the selected two images are an image viewed by a user's left eye through a parallax barrier, and an image viewed by a user's right eye through the parallax barrier. The two images are displayed on the upper LCD 22, thereby displaying a stereoscopically viewable image on the upper LCD 22.

FIG. 4 is a diagram illustrating an exemplary predetermined real object 50. The predetermined real object may be, for example, a figure of a specific person, or a head of a specific person. As shown in FIG. 4, the real object 50 is, for example, a cube including six faces (a face 50a to a face 50c, and a face 50d to a face 50f (the face 50d to the face 50f are not shown)). Numeral “1” is written on the face 50a of the real object 50, numeral “2” is written on the face 50b of the real object 50, and numeral “3” is written on the face 50c of the real object 50. Further, numeral “6” is written on the face 50d opposing the face 50a, numeral “5” is written on the face 50e opposing the face 50b, and numeral “4” is written on the face 50f opposing the face 50c, which are not shown in FIG. 4.

Images of the real object 50 shown in FIG. 4 are taken by a real camera from a plurality of directions, and are previously stored in the game apparatus 10. FIG. 5 is a diagram illustrating positions of the real camera which is set so as to take images of the real object 50 from a plurality of directions. As shown in FIG. 5, the real object 50 is positioned at a predetermined position O in the real space, and the real camera is positioned at a plurality of positions (P1 to Pn) on a hemisphere the center of which is the predetermined position O. The imaging direction of the real camera is set to a direction from each position of the real camera toward the predetermined position O, thereby taking the images of the real object 50. For example, the real camera is positioned at the position P1, and the imaging direction of the real camera is set to a direction from the position P1 toward the predetermined position O (the position at which the real object 50 is positioned). Further, the real camera is positioned at the position P2, and the imaging direction of the real camera is set to a direction from the position P2 toward the predetermined position O. Thus, the images of the real object 50 are taken from a plurality of positions, and a plurality of taken images are stored in storage means (for example, the external memory 44) of the game apparatus 10. When the images of the real object 50 are taken, one real camera may be used, or a plurality of cameras may be used. Specifically, a position and an orientation of one real camera may be sequentially changed to take the images of the real object 50. Alternatively, a plurality of real cameras may be previously positioned at different positions, and the images of the real object 50 may be simultaneously taken by the plurality of real cameras, thereby simultaneously obtaining a plurality of images.

In the present embodiment, a gazing point of the real camera is set to the position O (the center of the hemisphere) at which the real object 50 is positioned. However, in another embodiment, the gazing point of the real camera may be set to the center (the center of the cube) of the real object 50. Further, the positions in FIG. 5 at which the real camera is set are exemplary positions, and the real camera may be positioned on the hemisphere at equal spaces.

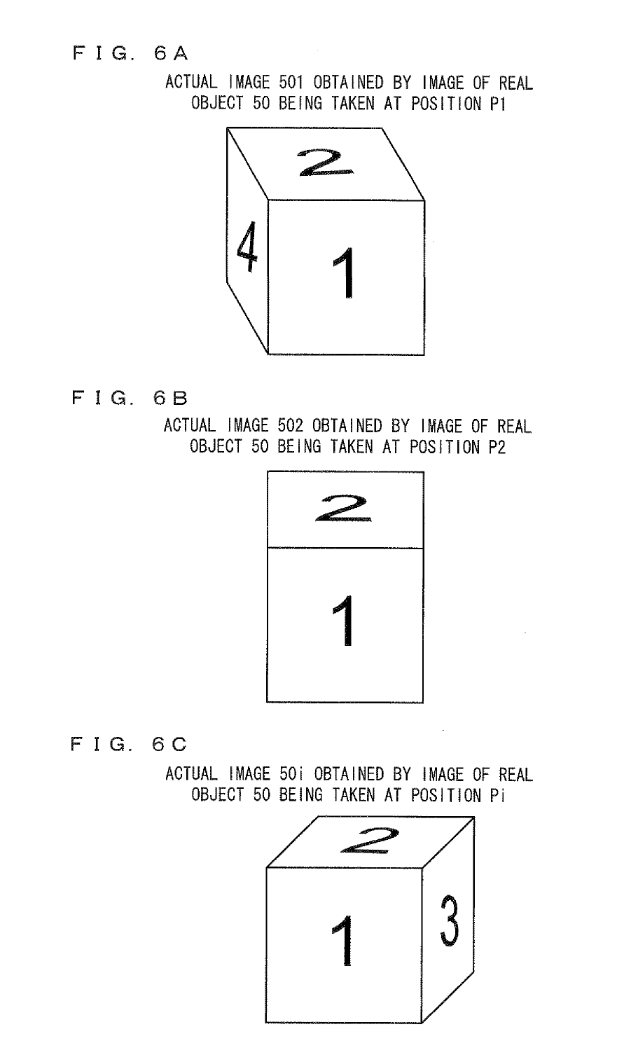

FIG. 6A is a diagram illustrating an exemplary actual image 501 obtained when an image of the real object 50 is taken at the position P1. FIG. 6B is a diagram illustrating an exemplary actual image 502 obtained when an image of the real object 50 is taken at the position P2. FIG. 6C is a diagram illustrating an exemplary actual image 50i obtained when an image of the real object 50 is taken at a position Pi. As shown in FIG. 6A, when an image of the real object 50 is taken at the position P1, the face 50a, the face 50b, and the face 50f are viewable, and the other faces are not viewable. As shown in FIG. 6B, when an image of the real object 50 is taken at the position P2, the face 50a and the face 50b are viewable, and the other faces are not viewable. Further, as shown in FIG. 6C, when an image of the real object 50 is taken at the position Pi, the face 50a, the face 50b, and the face 50c are viewable, and the other faces are not viewable.

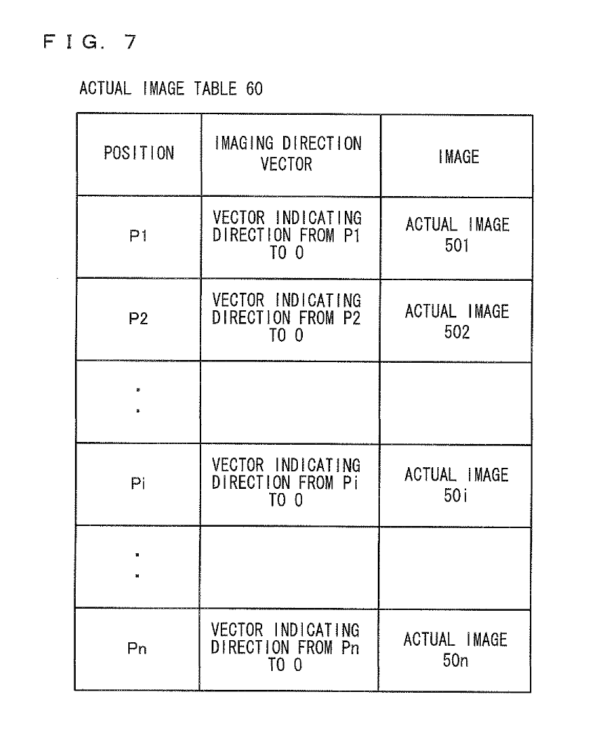

FIG. 7 is a diagram illustrating an actual image table 60 containing data of a plurality of actual images which are previously stored in the game apparatus 10. As shown in FIG. 7, a plurality of images of the real object 50 taken at each position on the hemisphere shown in FIG. 5 are stored in the game apparatus 10. Specifically, as shown in FIG. 7, each image (the actual image 501 to an actual image 50n) is stored so as to be associated with a position at which the image is taken, and an imaging direction vector. The imaging direction vector is a vector (unit vector) indicating a direction from a position of the real camera toward the predetermined position O (the position of the real object 50), and is stored in the actual image table 60. The imaging direction vector and the actual image which are associated with each other may be stored in the actual image table 60, and positions at which the real camera is positioned may not necessarily be stored.

When the real object 50 is photographed by the real camera, the photographed image includes the real object 50 and a background. Namely, an image obtained by photographing the real object 50 by using the real camera has a square or a rectangular shape in general, and includes an area of the real object 50, and an area other than the area of the real object 50. However, the portion corresponding to the background included in the photographed image is eliminated, and an image which does not include the portion of the background is stored. Therefore, each image stored in the actual image table 60 is an image representing only the real object 50 having been taken. Accordingly, the shape of each image stored in the actual image table 60 represents the silhouette of the real object 50, and, for example, the image 501 shown in FIG. 6A has a hexagonal shape.

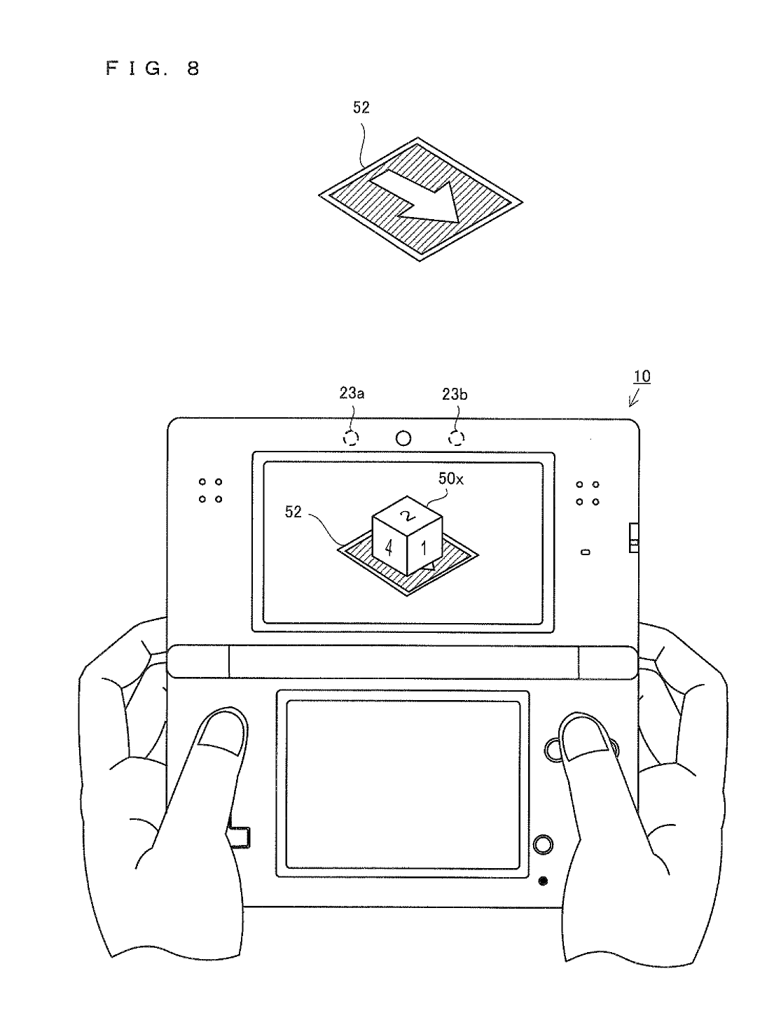

An image displayed on the upper LCD 22 of the game apparatus 10 under the condition that the plurality of images having been previously obtained as described above are stored in the game apparatus 10, will be described. FIG. 8 is a diagram illustrating an image displayed on the upper LCD 22 in a case where an image of a marker 52 positioned in the real space is taken by the outer imaging section 23 of the game apparatus 10.

As shown in FIG. 8, the marker 52 is positioned in the real space. The marker 52 is a piece of rectangular paper having an arrow drawn at the center thereof. The direction indicated by the arrow drawn at the center of the marker 52 is parallel with the long side of the marker 52. The game apparatus 10 performs, for example, image processing such as pattern matching on an image taken by the outer imaging section 23, thereby enabling detection of the marker 52 included in the image. As shown in FIG. 8, when the marker 52 is detected in the image taken by the outer imaging section 23, an image 50x obtained by taking an image of the real object 50 is superimposed on an image of the marker 52, and the superimposed image is displayed on the upper LCD 22.

Specifically, as shown in FIG. 8, when an image of the marker 52 is taken by the outer imaging section 23 such that the arrow of the marker 52 is diagonally indicated, an image in which the real object 50 appears to be placed on the marker 52 is displayed on the upper LCD 22. For example, the image of the real object 50 is displayed such that the face 50a of the real object 50 on which numeral “1” is written, the face 50b on which numeral “2” is written, and the face 50f on which numeral “4” is written, are viewable.

When the image of the marker 52 positioned in the real space is taken by the outer imaging section 23, one left selection image and one right selection image are selected from among the plurality of images (the actual image 501 to the actual image 50n) which are previously stored in the actual image table 60 shown in FIG. 7. The “left selection image” is an image selected from among the actual image 501 to the actual image 50n which are stored in the actual image table 60, and is viewed by a user's left eye. The “right selection image” is an image selected from among the actual image 501 to the actual image 50n which are stored in the actual image table 60, and is viewed by a user's right eye. The left selection image and the right selection image are displayed on the upper LCD 22, thereby displaying the stereoscopically viewable image 50x that is stereoscopic for a user.

The game apparatus 10 selects, as the left selection image, one image from among the plurality of images stored in the actual image table 60, based on a position and an orientation of the marker 52 included in the image obtained by the outer imaging section (left) 23a. On the other hand, the game apparatus 10 selects, as the right selection image, one image from among the plurality of images stored in the actual image table 60, based on a position and an orientation of the marker 52 included in the image obtained by the outer imaging section (right) 23b. An image selection method will be specifically described below.

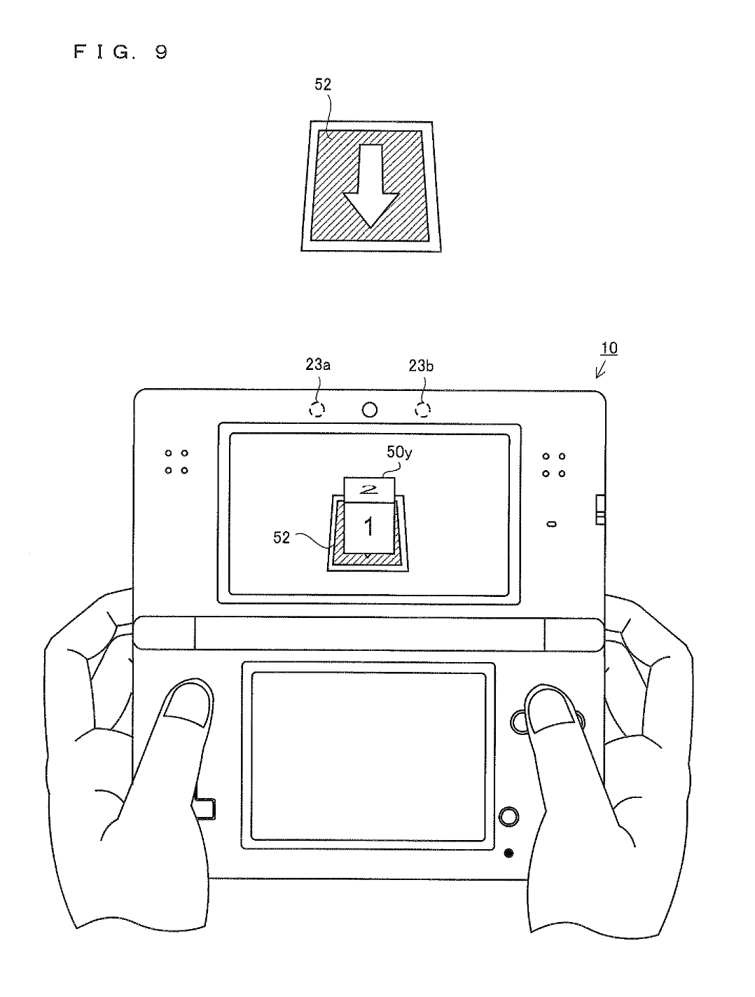

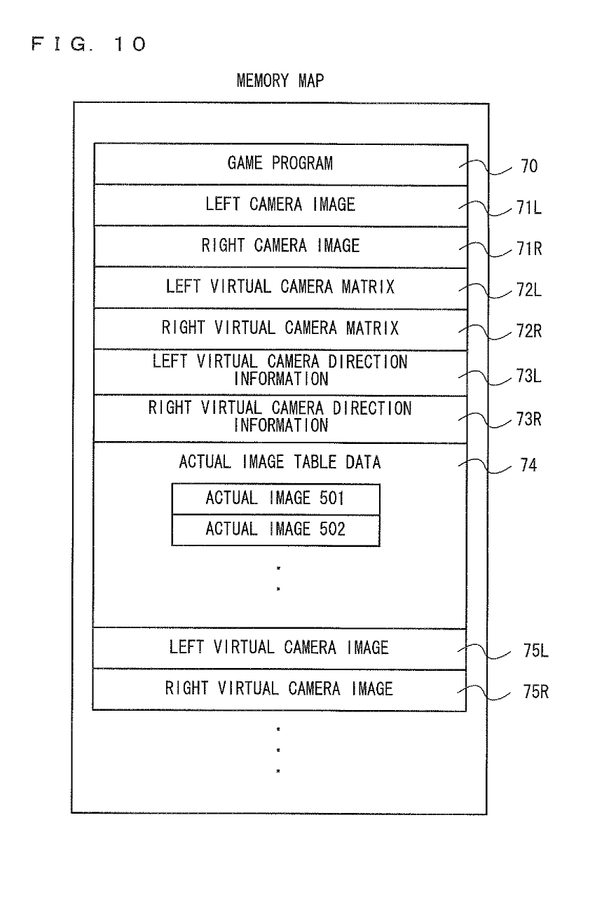

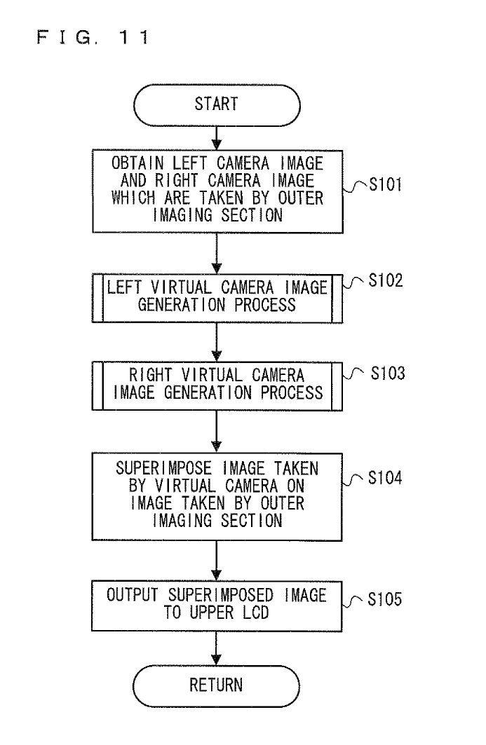

FIG. 9 is a diagram illustrating an image displayed on the upper LCD 22 in a case where an image of the marker 52 positioned in the real space is taken by the outer imaging section 23 of the game apparatus 10 from a direction different from the direction shown in FIG. 8

As shown in FIG. 9, when the marker 52 is detected in the image taken by the outer imaging section 23, an image 50y obtained by taking an image of the real object 50 is superimposed on an image of the marker 52, and the superimposed image is displayed on the upper LCD 22. The image 50y is a stereoscopically viewable image similarly to that as shown in FIG. 8, and actually includes two images.

As shown in FIG. 9, the marker 52 is positioned such that the direction of the arrow of the marker 52 indicates the front side, and an image of the marker 52 is taken by the outer imaging section 23. In this case, an image in which the real object 50 appears to be placed on the marker 52 is displayed on the upper LCD 22. Specifically, the image of the real object 50 is displayed on the upper LCD 22 such that the face 50a of the real object 50 on which numeral “1” is written, and the face 50b on which numeral “2” is written, are viewable.

As described above, in a case where an image of the marker 52 is taken by the outer imaging section 23, the real object 50 which is not actually positioned in the real space is displayed on the image of the marker 52. The image of the real object 50 displayed on the upper LCD 22 is an image obtained by actually photographing the real object 50 by using the camera. Therefore, a user feels as if the real object 50 is positioned in the real space.

(Details of Display Process)

Next, the display process according to the present embodiment will be described in detail with reference to FIG. 10 to FIG. 15. Firstly, main data which is stored in the main memory 32 and the VRAM 313 (hereinafter, these may be generically referred to as a RAM) in the display process will be described. FIG. 10 is a diagram illustrating a memory map of the RAM (the main memory 32 and the like) of the game apparatus 10. As shown in FIG. 10, a game program 70, a left camera image 71L, a right camera image 71R, a left virtual camera matrix 72L, a right virtual camera matrix 72R, left virtual camera direction information 73L, right virtual camera direction information 73R, actual image table data 74, a left virtual camera image 75L, a right virtual camera image 75R, and the like, are stored in the RAM. In addition thereto, for example, data associated with button operation performed by a user is stored in the RAM.

The game program 70 is a program for causing the information processing section 31 (the CPU 311) to execute the display process shown in the flow chart described below.

The left camera image 71L is an image which is taken by the outer imaging section (left) 23a, displayed on the upper LCD 22, and viewed by a user's left eye. The right camera image 71R is an image which is taken by the outer imaging section (right) 23b, displayed on the upper LCD 22, and is viewed by a user's right eye. The outer imaging section (left) 23a and the outer imaging section (right) 23b take the left camera image 71L and the right camera image 71R, respectively, at predetermined time intervals, and the left camera image 71L and the right camera image 71R are stored in the RAM.

The left virtual camera matrix 72L is a matrix indicating a position and an orientation of a left virtual camera 63a (see FIG. 13) based on a marker coordinate system defined on the marker 52. The right virtual camera matrix 72R is a matrix indicating a position and an orientation of a right virtual camera 63b (see FIG. 13) based on the marker coordinate system defined on the marker 52. The left virtual camera 63a is a virtual camera positioned in a virtual space, and is positioned at a position and an orientation in the virtual space which correspond to the position and the orientation, respectively, of the outer imaging section (left) 23a relative to the marker 52 in the real space. The right virtual camera 63b is a virtual camera positioned in the virtual space, and is positioned at a position and an orientation in the virtual space which correspond to the position and the orientation, respectively, of the outer imaging section (right) 23b relative to the marker 52 in the real space. The left virtual camera 63a and the right virtual camera 63h form and act as a virtual stereo camera 63, and the positions and the orientations thereof in the virtual space are represented as coordinate values of the marker coordinate system, and rotations around each axis in the marker coordinate system, respectively. Setting of the left virtual camera 63a, the right virtual camera 63b, and the marker coordinate system will be described below.

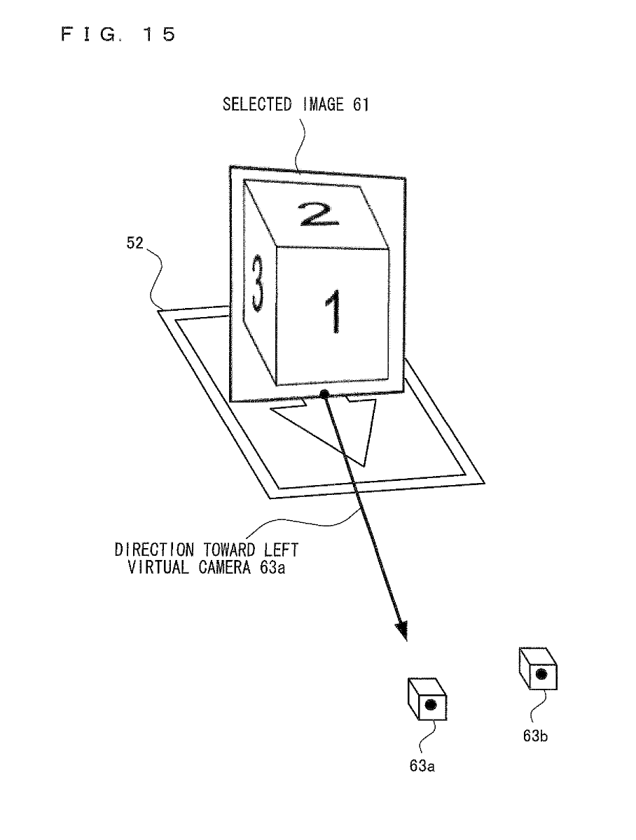

The left virtual camera direction information 73L is information representing a left virtual camera direction vector (FIG. 14) indicating a direction from a position of the left virtual camera 63a in the virtual space toward a predetermined position (the originating point of the marker coordinate system) in the virtual space. The right virtual camera direction information 73R is information representing a right virtual camera direction vector (FIG. 14) indicating a direction from a position of the right virtual camera 63b in the virtual space toward a predetermined position (the originating point of the marker coordinate system) in the virtual space. The left virtual camera direction vector and the right virtual camera direction vector will be described below.

The actual image table data 74 is data representing the actual image table 60 shown in FIG. 7. Specifically, in the actual image table data 74, image data of the actual image 501 to the actual image 50n which are obtained by taking images of the real object 50, are previously stored, and an imaging direction vector representing an imaging direction for each image is previously stored for each image.

The left virtual camera image 75L is an image which is obtained by the left virtual camera 63a taking an image of the virtual space, displayed on the upper LCD 22, and viewed by a user's left eye. The right virtual camera image 75R is an image which is obtained by the right virtual camera 63b taking an image of the virtual space, displayed on the upper LCD 22, and viewed by a user's right eye.

(Description of Flow Chart)

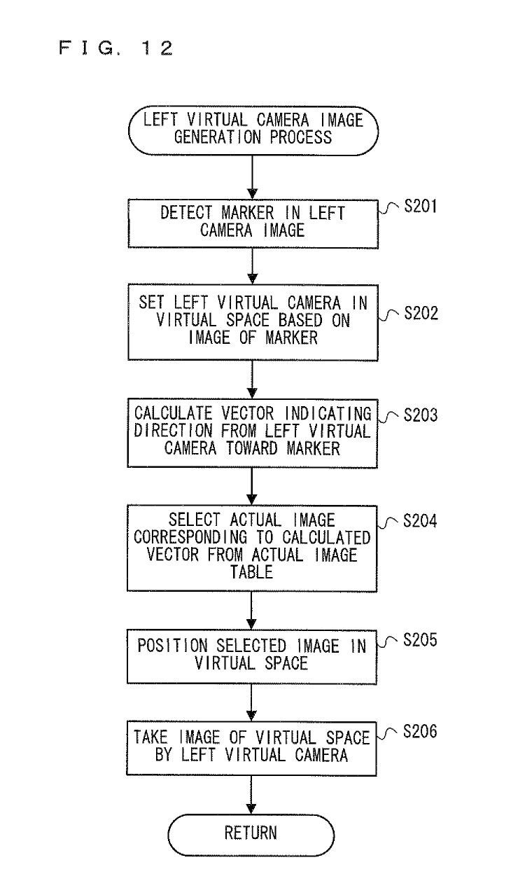

Next, the display process will be described in detail with reference to FIG. 11. FIG. 11 is a main flow chart showing in detail the display process according to the present embodiment. When the game apparatus 10 is powered on, the information processing section 31 (the CPU 311) of the game apparatus 10 executes a boot program stored in the ROM, thereby initializing each unit such as the main memory 32. Next, the game program 70 stored in a nonvolatile memory (the external memory 44, and the like; a computer-readable storage medium) is loaded into the RAM (specifically, the main memory 32), and the CPU 311 of the information processing section 31 starts the execution of the program. The process shown in the flow chart of FIG. 11 is performed by the information processing section 31 (the CPU 311 or the GPU 312) after the above-described process steps have been completed.

In FIG. 11, description for process steps which are not directly associated with the present invention is omitted. Further, the process steps of step S101 to step S105 shown in FIG. 11 are repeatedly performed every one frame (for example, every 1/30 seconds or every 1/60 seconds, which are referred to as a frame time).

Firstly, in step S101, the information processing section 31 obtains images taken by the outer imaging section 23. Specifically, the information processing section 31 obtains an image taken by the outer imaging section (left) 23a, and stores the image as the left camera image 71L in the RAM. Further, the information processing section 31 obtains an image taken by the outer imaging section (right) 23b, and stores the image as the right camera image 71R in the RAM. Next, the information processing section 31 executes a process step of step S102.

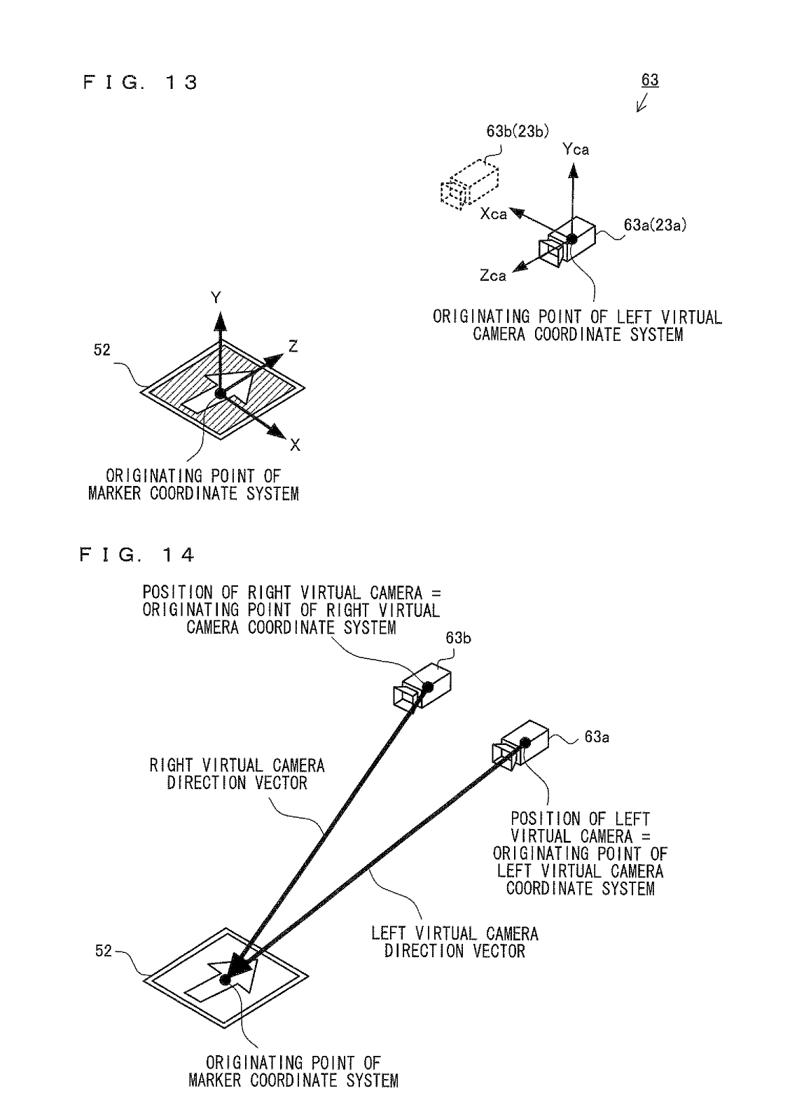

In step S102, the information processing section 31 performs a left virtual camera image generation process. In the present embodiment, the left virtual camera 63a takes an image of the virtual space, thereby generating the left virtual camera image 75L. The left virtual camera image generation process of step S102 will be described in detail with reference to FIG. 12.

FIG. 12 is a flow chart showing in detail the left virtual camera image generation process (step S102).

In step S201, the information processing section. 31 detects the left camera image 71L obtained in step S101 for the marker 52. Specifically, the information processing section 31 detects the left camera image 71L obtained in step S101 for the marker 52 by using, for example, a pattern matching technique. When the information processing section 31 has detected the marker 52, the information processing section 31 then executes a process step of step S202. When the information processing section 31 does not detect the marker 52 in step S201, the subsequent process steps of step S202 to step S206 are not performed, and the information processing section 31 ends the left virtual camera image generation process.

In step S202, the information processing section 31 sets the left virtual camera 63a in the virtual space based on the image of the marker 52 which has been detected in step S201, and is included in the left camera image 71L. Specifically, based on the position, the shape, the size, and the orientation of the image of the marker 52 having been detected, the information processing section 31 defines the marker coordinate system on the marker 52, and calculates a positional relationship in the real space between the marker 52 and the outer imaging section (left) 23a. The information processing section 31 determines the position and the orientation of the left virtual camera 63a in the virtual space based on the calculated positional relationship.

FIG. 13 is a diagram illustrating a positional relationship between the marker coordinate system defined on the marker 52, and the left virtual camera 63a set in the virtual space. As shown in FIG. 13, when the information processing section 31 has detected the marker 52 in the left camera image 71L, the information processing section 31 defines the marker coordinate system (XYZ coordinate system) on the marker 52. The originating point of the marker coordinate system is set to the center of the marker 52. The Z-axis of the marker coordinate system is defined along a direction from the center of the marker 52 as indicated by the arrow drawn on the marker 52. The X-axis of the marker coordinate system is defined along the rightward direction relative to the direction indicated by the arrow drawn on the marker 52. The Y-axis of the marker coordinate system is defined along the upward direction orthogonal to the marker 52. Thus, the marker coordinate system is defined relative to the marker 52, so that the virtual space defined by the marker coordinate system is associated with the real space. For example, the center of the marker 52 in the real space is associated with a predetermined point (the originating point of the marker coordinate system) in the virtual space.

Further, the information processing section 31 calculates a positional relationship in the real space between the marker 52 and the outer imaging section (left) 23a, based on the image of the marker 52 included in the left camera image 71L. The positional relationship between the marker 52 and the outer imaging section (left) 23a represents a position and an orientation of the outer imaging section (left) 23a relative to the marker 52. Specifically, the information processing section 31 calculates, based on the position, the shape, the size, the orientation, and the like of the image of the marker 52 in the left camera image 71L, a matrix representing the position and the orientation of the outer imaging section (left) 23a relative to the marker 52. The information processing section 31 determines the position and the orientation of the left virtual camera 63a in the virtual space so as to correspond to the calculated position and orientation of the outer imaging section (left) 23a. Specifically, the information processing section 31 stores the calculated matrix as the left virtual camera matrix 72L in the RAM. In such a manner, the left virtual camera 63a is set, so that the position and the orientation of the outer imaging section (left) 23a in the real space are associated with the position and the orientation of the left virtual camera 63a in the virtual space. As shown in FIG. 13, the left virtual camera matrix 72L is a coordinate transformation matrix for transforming, in the virtual space, a coordinate represented according to the marker coordinate system (XYZ coordinate system), into a coordinate represented according to a left virtual camera coordinate system (XcaYcaZca coordinate system). The left virtual camera coordinate system is a coordinate system in which the position of the left virtual camera 63a is defined as the originating point, and the Zca-axis is defined along the imaging direction of the left virtual camera 63a, the Xca-axis is defined along the rightward direction relative to the Zca-axis, and the Yea-axis is defined along the upward direction relative to the Zca-axis.

The information processing section 31 executes a process step of step S203 subsequent to the process step of step S202.

In step S203, the information processing section 31 calculates a vector indicating a direction from the left virtual camera 63a toward the marker 52. Specifically, the information processing section 31 calculates the left virtual camera direction vector starting at the position of the left virtual camera 63a (the position represented by the left virtual camera matrix 72L) and ending at the originating point of the marker coordinate system. FIG. 14 illustrates the left virtual camera direction vector calculated in step S203. As shown in FIG. 14, the left virtual camera direction vector is a vector indicating a direction from the position of the left virtual camera 63a represented according to the marker coordinate system toward the originating point of the marker coordinate system. The information processing section 31 stores the calculated vector as the left virtual camera direction information 73L in the RAM. Next, the information processing section 31 executes a process step of step S204.

In step S204, the information processing section 31 selects one actual image from the actual image table 60, based on the vector calculated in step S203. Specifically, the information processing section 31 compares the calculated vector with each imaging direction vector in the actual image table 60, and selects a vector which is equal to (or closest to) the calculated vector. The information processing section 31 selects, from the actual image table 60, an image (one of the actual image 501 to the actual image 50n) corresponding to the selected vector. For example, the information processing section 31 obtains a value of an inner product of the vector calculated in step S203 and each imaging direction vector in the actual image table 60, and selects an imaging direction vector by which the greatest value of the inner product is obtained, and selects an image corresponding to the imaging direction vector having been selected. Next, the information processing section 31 executes a process step of step S205.

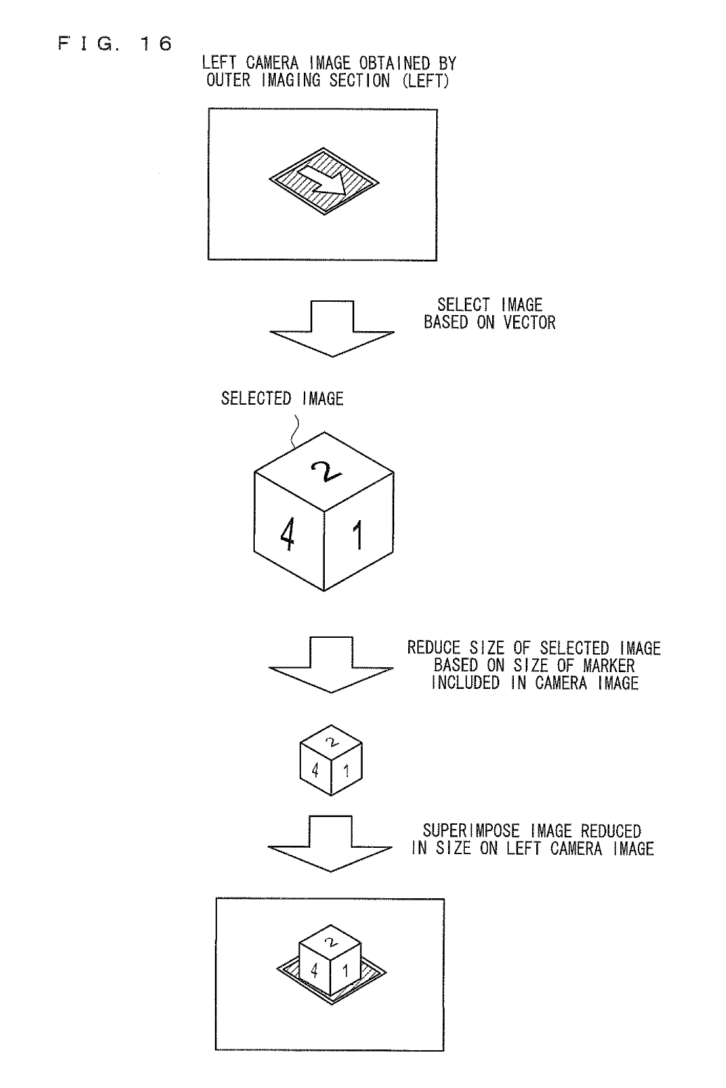

In step S205, the information processing section 31 positions, in the virtual space, the image selected in step S204. FIG. 15 is a diagram illustrating a state in which an image 61 selected in step S204 is positioned in the virtual space.

As shown in FIG. 15, the position of the image 61 having been selected is set to the originating point of the marker coordinate system. Specifically, the horizontal center of the base of the image 61 having been selected is set to the originating point of the marker coordinate system. Further, an orientation of the image 61 having been selected is determined according to the orientation of the left virtual camera 63a. Specifically, the image 61 is positioned in the virtual space such that the image 61 is oriented toward the left virtual camera 63a (the originating point of the camera coordinate system of the left virtual camera 63a). The image 61 positioned in the virtual space can be handled as a two-dimensional object (image object). This image object is obtained by mapping the selected image on a plate-shaped object as a texture. When an image of the two-dimensional image object representing the image 61 selected in step S204 is taken by the left virtual camera 63a, the image object is positioned in the virtual space such that the image of the two-dimensional image object is taken from the front. If the image object is not positioned so as to be oriented toward the left virtual camera 63a, when an image of the virtual space is taken by the left virtual camera 63a, an image of the image object is diagonally taken, and the resultant image is an image obtained by diagonally viewing the image 61 having been selected. However, in step S205, the two-dimensional image object representing the image 61 having been selected is positioned in the virtual space so as to be oriented toward the left virtual camera 63a. Therefore, an image obtained by an image of the virtual space being taken by the left virtual camera 63a is an image which is obtained by the image 61 having been selected being viewed from the front thereof.

As described above, each image stored in the actual image table 60 represents only the real object 50 (each image does not include a background other than the real object 50). Therefore, although, in FIG. 15, the two-dimensional image object positioned in the virtual space looks like a square or a rectangular object, the two-dimensional image object actually has a shape representing the outer edge of the real object 50. Namely, the shape of the two-dimensional image object is a shape representing the outer edge of the image of the real object 50 which is actually positioned on the marker 52 in the real space, and viewed from the position of the outer imaging section (left) 23a. Therefore, the image 61 shown in FIG. 15 is actually an image of the real object 50 only.

Moreover, in order to orient the image 61 having been selected toward the left virtual camera 63a, the image object may be positioned such that the normal line of the two-dimensional image object representing the image 61 having been selected is parallel with the imaging direction of the left virtual camera 63a (an angle between the normal line vector and the imaging direction vector is 180 degrees). Further, in order to orient the image 61 having been selected toward the left virtual camera 63a, the image object may be positioned such that a straight line connecting between the position of the left virtual camera 63a and the originating point of the marker coordinate system is orthogonal to the two-dimensional image object.

Further, when the gazing point of the real camera for taking the plurality of images (the actual images 501 to 50n) to be previously stored is set to the center of the real object 50, the image 61 having been selected may be positioned in the virtual space such that the center of the image 61 having been selected corresponds to the originating point of the marker coordinate system.

The information processing section 31 executes a process step of step S206 subsequent to the process step of step S205.

In step S206, the information processing section 31 takes an image of the virtual space by using the left virtual camera 63a, to generate the left virtual camera image 75L. The information processing section 31 stores, in the RAM, the left virtual camera image 75L having been generated. Subsequent to the process step of step S206, the information processing section 31 ends the left virtual camera image generation process.

Returning to FIG. 11, the information processing section 31 executes the right virtual camera image generation process in step S103. The right virtual camera image generation process of step S103 is performed in the same manner as the left virtual camera image generation process of step S102. In step S103, the information processing section 31 detects the maker 52 in the right camera image 71R obtained in step S101, and sets the right virtual camera 63b in the virtual space based on the image of the marker 52. Next, the information processing section 31 calculates a vector (the right virtual camera direction vector shown in FIG. 14) indicating a direction from the right virtual camera 63b toward the marker 52, and selects an image from the actual image table 60 based on the vector. The information processing section 31 positions, in the virtual space, the two-dimensional image object representing the selected image, and takes an image of the virtual space by using the right virtual camera 63b, to generate the right virtual camera image 75R. The information processing section 31 stores, in the RAM, the right virtual camera image 75R having been generated, and ends the process step of step S103. Next, the information processing section 31 executes a process step of step S104.

In step S104, the information processing section 31 superimposes the image taken by the virtual stereo camera 63 on the image taken by the outer imaging section 23. Specifically, the information processing section 31 superimposes the left virtual camera image 75L generated in step S102, on the left camera image 71L obtained in step S101, to generate a left superimposed image. Further, the information processing section 31 superimposes the right virtual camera image 75R generated in step S103, on the right camera image 71R having been obtained in step S101, to generate a right superimposed image. Next, the information processing section 31 executes a process step of step S105.

In step S105, the information processing section 31 outputs, to the upper LCD 22, the left superimposed image and the right superimposed image generated in step S104. The left superimposed image is viewed by a user's left eye through the parallax barrier of the upper LCD 22, while the right superimposed image is viewed by a user's right eye through the parallax barrier of the upper LCD 22. Thus, a stereoscopically viewable image which is stereoscopic for a user is displayed on the upper LCD 22. This is the end of the description of the flow chart shown in FIG. 11.

As described above, in the present embodiment, images obtained by taking images of a real object from a plurality of directions are previously prepared, and images are selected from among the plurality of image having been prepared, according to the orientation (direction) of the marker 52 as viewed from the game apparatus 10 (the outer imaging section 23). The selected images are superimposed on the image taken by the outer imaging section 23, and the superimposed image is displayed on the upper LCD 22. Thus, a user can feel as if a real object which does not actually exist in the real space exists in the real space.

Further, the two-dimensional image object of the selected image is positioned on the marker 52 included in the image taken by the outer imaging section 23 so as to be oriented toward the virtual camera, and an image of the virtual space including the image object is taken by the virtual camera. The virtual camera is positioned in the virtual space at a position and an orientation corresponding to those of the outer imaging section 23. Thus, the size of the selected image can be varied according to a distance in the real space between the marker 52 and the outer imaging section 23. Therefore, a user can feel as if the real object exists in the real space.

(Modifications)

In the present embodiment, the plurality of images which are previously prepared are images obtained by images of the real object 50 being taken by the real camera from a plurality of directions. In another embodiment, the plurality of images which are previously prepared may be images obtained by images of a three-dimensional virtual object being taken by the virtual camera from a plurality of directions. The three-dimensional virtual object is stored in the game apparatus 10 as model information representing a shape and a pattern of the three-dimensional virtual object, and the game apparatus 10 takes an image of the three-dimensional virtual object by using the virtual camera, thereby generating an image of the virtual object. However, when a virtual object having a complicated shape, or a virtual object including a great number of polygons is rendered, the processing load on the game apparatus 10 is increased, and the rendering process may not be completed in time for updating of a screen. Therefore, a plurality of images obtained by taking images of a specific virtual object may be previously prepared, and images to be displayed may be selected from among the prepared images, thereby displaying an image of the virtual object with a low load. Namely, a plurality of images obtained by taking images of a predetermined photographed subject (the photographed subject may be a real object or may be a virtual object) from a plurality of direction may be previously prepared.

Further, in another embodiment, the plurality of images which are previously prepared may be other than images taken by the real camera or the virtual camera. For example, the plurality of images which are previously prepared may be images obtained by a user handdrawing a certain subject as viewed from a plurality of directions. Further, in still another embodiment, the plurality of images which are previously prepared may not necessarily be images representing a specific real object (or virtual object) viewed from a plurality of directions. For example, a plurality of images obtained by taking images of different real objects (or virtual objects) are previously prepared, and images may be selected from among the plurality of images having been prepared, based on a direction in which an image of the marker 52 is taken, and the selected images may be displayed. For example, when an image of the marker 52 is taken from a certain direction, a certain object is displayed, whereas when an image of the marker 52 is taken from another direction, a different object may be displayed.

Further, in the present embodiment, a selected image is superimposed and displayed on an actual image taken by the outer imaging section 23. In another embodiment, only the selected image may be displayed.

Further, in the present embodiment, the image of the real object 50 is displayed at the center of the marker 52. In another embodiment, the real object 50 may not necessarily be positioned at the center of the marker 52, and may be positioned at a predetermined position in the marker coordinate system. In this case, for example, when the left virtual camera image is generated, a vector indicating a direction from the position of the left virtual camera 63a toward the predetermined position is calculated, and one image is selected from among previously prepared images based on the calculated vector. The selected image is positioned at the predetermined position, so as to be oriented toward the left virtual camera 63a.

Moreover, in the present embodiment, the marker coordinate system is defined on the marker 52 based on the marker 52 included in the taken image, and the position of the outer imaging section 23 in the marker coordinate system is calculated. Namely, in the present embodiment, one of the outer imaging section 23 and the marker 52 is used as a reference, and the orientation and the distance of the other thereof relative to the reference are calculated. In another embodiment, only the relative orientation between the outer imaging section 23 and the marker 52 may be calculated. Namely, the direction in which the marker 52 is viewed is calculated, and one image may be selected from among the plurality of images having been previously stored, based on the calculated direction.

Furthermore, in the present embodiment, an image of the two-dimensional image object representing the selected image is positioned in the virtual space so as to be oriented toward the virtual camera, and an image of the virtual space is taken by the virtual camera. Thus, the real object 50 is displayed such that the size of the real object 50 displayed on the upper LCD 22 is varied according to the relative position between the marker 52 and the outer imaging section. In another embodiment, the size of the real object 50 displayed may be varied in another manner. For example, the size of the selected image is varied without positioning the selected image in the virtual space, and the image having its size varied may be displayed as it is on the upper LCD 22. Specifically, for example, the size of the selected image may be enlarged or reduced, based on the size of the image of the marker 52 included in the left camera image 71L, and the image having the enlarged size or reduced size may be superimposed on the image of the marker 52 included in the left camera image 71L, and the superimposed image may be displayed on the upper LCD 22.

FIG. 16 is a diagram illustrating an outline of a display process according to another embodiment. As shown in FIG. 16, for example, the game apparatus 10 firstly detects the left camera image taken by the outer imaging section (left) 23a, for an image of the marker 52 included in the left camera image. Next, the game apparatus 10 selects one image from among a plurality of images having been previously prepared in the same manner as described above. Subsequently, the game apparatus 10 reduces (or enlarges) the size of the selected image, based on the size of the image of the marker 52 included in the left camera image. Specifically, the game apparatus 10 calculates a ratio of the size of the marker 52 to a predetermined size, and reduces (or enlarges) the size of the selected image according to the ratio. The game apparatus 10 superimposes the image having the reduced (or enlarged) size on the left camera image. In this case, for example, the game apparatus 10 superimposes the image having the reduced (or enlarged) size on the left camera image such that the center of the image having the reduced (or enlarged) size matches with the center of the marker 52 included in the left camera image.

Furthermore, in the present embodiment, another virtual object is not positioned in virtual space. In another embodiment, a plurality of virtual objects may be positioned in the virtual space, and the virtual objects, the marker 52 in the real space, and the image of the real object 50 may be displayed on the upper LCD 22.

For example, a ground object representing the ground may be positioned on an XZ-plane. The ground object may represent a smooth plane or an uneven plane. In this case, the selected image may be positioned so as not to contact with the ground object. For example, the selected image may be positioned so as to float above the ground object such that the selected image does not contact with the ground object. Alternatively, in a portion where the selected image contacts with the ground object, the ground object may be rendered preferentially over the selected image. For example, if the selected image is preferentially rendered in the portion where the selected image contacts with the ground object, a portion of the real object which should be buried in the ground may be displayed in the displayed image, so that the image may look strange. However, when the selected image is positioned so as not to contact with the ground object, or the ground object is preferentially rendered if the selected image and the ground object contact with each other, an image which does not look strange can be displayed.

Further, for example, a virtual character may be positioned in the virtual space, photographs representing a face of a specific person may be taken from a plurality of directions, the photographs may be stored in storage means, one photograph may be selected from among the plurality of photographs, and the face of the virtual character may be replaced with the selected photograph, to display the obtained image. In this case, for example, when the body of the virtual character is oriented rightward, a photograph representing a right profile face may be mapped on the portion of the face of the virtual character, and the obtained image is displayed. Further, in this case, when another virtual object (or another part (such as a hand) of the virtual character) positioned in the virtual space is positioned closer to the virtual camera than the portion of the face of the virtual character is, the other virtual object is preferentially displayed. Thus, an image in which the most recent real space, objects in the virtual space, and a real object which does not exist in the real space at present are combined can be displayed so as to prevent the image from looking strange.

Further, in the present embodiment, the marker 52 has a rectangular planar shape. In another embodiment, any type of marker may be used. A marker (specific object) having a solid shape may be used.

Moreover, in the present embodiment, a positional relationship (relative orientation and distance) between the outer imaging section (left) 23a and the marker 52 is calculated by using the left camera image 71L taken by the outer imaging section (left) 23a, and a positional relationship (relative orientation and distance) between the outer imaging section (right) 23b and the marker 52 is calculated by using the right camera image 71R taken by the outer imaging section (right) 23b. In another embodiment, one of the images (for example, the left camera image 71L) may be used to calculate the positional relationship between the marker 52 and the corresponding one of the imaging sections (in this case, the outer imaging section (left) 23a), and the positional relationship between the marker 52 and the other of the imaging sections (in this case, the outer imaging section (right) 23b) may be calculated based on the positional relationship between the marker 52 and the corresponding one of the imaging sections (in this case, the outer imaging section (left) 23a). The outer imaging section (left) 23a and the outer imaging section (right) 23b are spaced from each other by a predetermined distance, and are secured to the game apparatus 10 in the same orientation. Therefore, when the position and orientation of one of the imaging sections are calculated, the position and the orientation of the other of the imaging sections can be calculated.

Further, in the present embodiment, a stereoscopically viewable image is displayed on the upper LCD 22. However, in another embodiment, a planer view image may be displayed on the upper LCD 22 or the lower LCD 12. For example, one of the imaging sections (any one of the two imaging sections of the outer imaging section 23, or another imaging section) takes an image of the marker 52 in the real space, and one image may be selected from among a plurality of images having been previously stored, based on the orientation of the marker 52 included in the taken image. The selected image may be superimposed on the taken image, and the superimposed image may be displayed on the upper LCD 22.

Moreover, in the present embodiment, one image is selected from among a plurality of images based on an orientation of the marker 52 included in an image taken by one imaging section, and is displayed. In another embodiment, one or more image may be selected from among a plurality of images based on an orientation of the marker 52 included in an image taken by one imaging section, and may be displayed. For example, based on an image taken by any one of the two imaging sections of the outer imaging section 23, a vector indicating a direction from the one of the two imaging sections of the outer imaging section 23 toward the center of the marker 52 is calculated, and two images corresponding to the vector is selected from the actual image table 60. The selected two images form a parallax, and one of the two images is viewed by a user's left eye, and the other of the two images is viewed by a user's right eye. The selected two images are displayed on the upper LCD 22, thereby displaying a stereoscopically viewable image of the real object 50. Further, for example, the image selected as described above is displayed on the upper LCD 22, and an image that is taken from a direction different than a direction from which the image has been taken so as to be displayed on the upper LCD 22 may be displayed on the lower LCD 12, and planer view images of the real object 50 taken from the different directions may be displayed. Specifically, for example, an image may be selected according to a vector indicating a direction from one of the imaging sections of the outer imaging section 23 toward the marker 52, and be displayed on the upper LCD 22, and an image may be selected according to a vector indicating a direction opposite to the direction of the vector from the one of the imaging sections of the outer imaging section 23 toward the marker 52, and be displayed on the lower LCD 12. Further, two (or more) images selected based on the orientation of the marker 52 included in an image taken by one imaging section may be displayed on one display device. For example, among images of the real object 50 based on the orientation of the marker 52 included in the taken image, an image of the real object 50 as viewed from the front thereof, an image of the real object 50 as viewed from the right side thereof, and an image of the real object 50 as viewed from the left side thereof may be displayed on one display device.

Moreover, in the present embodiment, the augmented reality effect is realized by using a video see-through method. Namely, in the present embodiment, images taken by the virtual camera (the left and the right virtual cameras) are superimposed on an image taken by the outer imaging section 23, to generate a superimposed image, and the superimposed image is displayed on the upper LCD 22. In another embodiment, the augmented reality effect may be realized by using an optical see-through method. For example, a user may wear a head-mounted display including a camera for detecting for a marker positioned in the real space, and the user may be allowed to view the real space through a display section corresponding to a lens portion of glasses. The display section is formed of a material which enables transmission of a real space such that the real space can be transmitted directly to the user's eyes, and further enables an image of the virtual object generated by a computer to be displayed.

Furthermore, in another embodiment, the display control method described above may be applied to a stationary game apparatus, and any other electronic devices such as personal digital assistants (PDAs), highly-functional mobile telephones, and personal computers, as well as to the hand-held game apparatus.

Further, in the present embodiment, an LCD capable of displaying a stereoscopically viewable image which is viewable with naked eyes is used as a display device. In another embodiment, the present invention is also applicable to, for example, a method (time-division method, polarization method, anaglyph method (red/cyan glasses method)) in which a stereoscopically viewable image that is viewable with glasses is displayed, and a method in which a head-mounted display is used. Furthermore, in another embodiment, a display device for displaying planer view images may be used instead of an LCD capable of displaying stereoscopically viewable images.

Further, in another embodiment, a plurality of information processing apparatuses may be connected so as to perform, for example, wired communication or wireless communication with each other, and may share the processes, thereby forming a display control system realizing the display control method described above. For example, a plurality of images which are previously prepared may be stored in a storage device which can be accessed by the game apparatus 10 via a network. Further, the program may be stored in, for example, a magnetic disk, or an optical disc as well as a nonvolatile memory. Further, the program may be stored in a RAM in a server connected to a network, and provided via the network.

Moreover, in the embodiment describe above, the information processing section 31 of the game apparatus 10 executes a predetermined program, to perform the processes shown above in the flow chart. In another embodiment, some or the entirety of the process steps described above may be performed by a dedicated circuit included in the game apparatus 10.

While the invention has been described in detail, the foregoing description is in all aspects illustrative and not restrictive. It is to be understood that numerous other modifications and variations can be devised without departing from the scope of the invention.

What is claimed is:

1. A computer-readable storage medium having stored therein an information processing program, the information processing program causing a computer of an information processing apparatus to function as:
image obtaining means for obtaining an image taken by imaging means;
specific object detection means for detecting a specific object in the image obtained by the image obtaining means;
calculation means for calculating an orientation of one of the specific object and the imaging means relative to the other thereof;
image selection means for selecting at least one image from among a plurality of images which are previously stored in storage means, based on the orientation calculated by the calculation means; and
display control means for causing a display device to display the at least one image selected by the image selection means.

2. The computer-readable storage medium having stored therein the information processing program according to claim 1, wherein
the plurality of images stored in the storage means is a plurality of images representing a predetermined object viewed from a plurality of directions, and
the image selection means selects the at least one image based on the orientation, from among the plurality of images.

3. The computer-readable storage medium having stored therein the information processing program according to claim 1, wherein
the calculation means calculates a position of one of the specific object and the imaging means relative to the other thereof, and
the image selection means selects an image from among the plurality of images, based on a direction from the position calculated by the calculation means toward a predetermined position satisfying a predetermined positional relationship with the specific object, or based on a direction from the predetermined position toward the position calculated by the calculation means.

4. The computer-readable storage medium having stored therein the information processing program according to claim 3, wherein
the display control means includes:
virtual camera setting means for setting a virtual camera in a virtual space, based on the position calculated by the calculation means;
positioning means for positioning, in the virtual space, an image object representing the selected image such that the image object is oriented toward the virtual camera; and
image generation means for generating an image by taking an image of the virtual space with the virtual camera, and
the display control means causes the display device to display the image generated by the image generation means.

5. The computer-readable storage medium having stored therein the information processing program according to claim 4, wherein the image object is a plate-shaped object on which the selected image is mapped as a texture.

6. The computer-readable storage medium having stored therein the information processing program according to claim 4, wherein
a predetermined virtual object is positioned in the virtual space, and
the image generation means generates an image by taking, with the virtual camera, an image of the virtual space including the predetermined virtual object and the selected image.

7. The computer-readable storage medium having stored therein the information processing program according to claim 6, wherein the positioning means positions the selected image in the virtual space so as to prevent the selected image from contacting with the predetermined virtual object.

8. The computer-readable storage medium having stored therein the information processing program according to claim 1, wherein
the calculation means calculates a position of one of the specific object and the imaging means relative to the other thereof, and
the display control means causes the display device to display the at least one image having been selected so as to vary, when the at least one image having been selected is displayed by the display device, the size of the at least one image having been selected, according to the position calculated by the calculation means.

9. The computer-readable storage medium having stored therein the information processing program according to claim 1, wherein the display control means causes the display device to display a superimposed image obtained by superimposing the at least one image having been selected, on one of the image taken by the imaging means, and a real space which is viewed through a screen of the display device.

10. The computer-readable storage medium having stored therein the information processing program according to claim 1, wherein
the imaging means includes a first imaging section and a second imaging section,
the calculation means calculates a first orientation representing an orientation of one of the specific object and the first imaging section relative to the other thereof, and a second orientation representing an orientation of one of the specific object and the second imaging section relative to the other thereof,
the image selection means selects a first image from among the plurality of images, based on the first orientation calculated by the calculation means, and selects a second image from among the plurality of images, based on the second orientation calculated by the calculation means, and
the display control means causes a display device capable of stereoscopically viewable display to display a stereoscopically viewable image by displaying, on the display device, the first image and the second image which are selected by the image selection means.

11. The computer-readable storage medium having stored therein the information processing program according to claim 1, wherein the plurality of images are images obtained by taking, with a real camera, images of a real object positioned in a real space.

12. The computer-readable storage medium having stored therein the information processing program according to claim 10, wherein
the plurality of images are images obtained by taking, with a monocular real camera, images of a real object positioned in a real space, and
the image selection means selects the first image from among the plurality of images taken by the monocular real camera, based on the first orientation, and selects the second image from among the plurality of images taken by the monocular real camera, based on the second orientation.

13. The computer-readable storage medium having stored therein the information processing program according to claim 1, wherein the plurality of images are images obtained by taking, with a virtual camera, images of a virtual object positioned in a virtual space.

14. An information processing apparatus comprising:
image obtaining means for obtaining an image taken by imaging means;
specific object detection means for detecting a specific object in the image obtained by the image obtaining means;
calculation means for calculating an orientation of one of the specific object and the imaging means relative to the other thereof;
image selection means for selecting at least one image from among a plurality of images which are previously stored in storage means, based on the orientation calculated by the calculation means; and
display control means for causing a display device to display the at least one image selected by the image selection means.

15. An information processing method comprising:
an image obtaining step of obtaining an image taken by imaging means;
a specific object detection step of detecting a specific object in the image obtained by the image obtaining step;
a calculation step of calculating an orientation of one of the specific object and the imaging means relative to the other thereof;
an image selection step of selecting at least one image from among a plurality of images which are previously stored in storage means, based on the orientation calculated by the calculation step; and
a display control step of causing a display device to display the at least one image selected by the image selection step.

16. An information processing system comprising an information processing apparatus and a marker, the information processing system comprising
the information processing apparatus including :
image obtaining means for obtaining an image taken by imaging means;
specific object detection means for detecting a specific object in the image obtained by the image obtaining means;
calculation means for calculating an orientation of one of the specific object and the imaging means relative to the other thereof;
image selection means for selecting at least one image from among a plurality of images which are previously stored in storage means, based on the orientation calculated by the calculation means; and
display control means for causing a display device to display the at least one image selected by the image selection means.
